(19) United States
(12) Patent Application Publication
(10) Pub. No.: US 2026/0328034 A1
(43) Pub. Date: Oct. 22, 2026

(54) WINDOW REGULATOR

(71) Applicant: AISIN CORPORATION, Kariya (JP)

(72) Inventor: Kazuki NATSUME, Kariya-shi (JP)

(73) Assignee: AISIN CORPORATION, Kariya (JP)

(21) Appl. No.: 19/641,062

(22) Filed: Apr. 7, 2026

(30) Foreign Application Priority Data
Apr. 18, 2025 (JP) 2025-069085

(51) Int. Cl. E05D 15/16; E05F 15/689

(52) U.S. Cl. CPC E05D 15/165; E05F 15/6916; E05Y 2201/64; E05Y 2201/684; E05Y 2900/55

(57) ABSTRACT

A window regulator for raising and lowering a door glass of a vehicle door includes: a first carrier plate and a second carrier plate each fixed to the door glass at a predetermined interval; a first guide rail extending in an upper-lower direction and into which the first carrier plate is slidably fitted; a second guide rail extending parallel to the first guide rail and into which the second carrier plate is slidably fitted; a plurality of pulleys respectively provided at end portions of the first and second guide rails in an extending direction; a raising-side wire having one end fixed to the first carrier plate and supported by the corresponding pulley; a lowering-side wire having one end fixed to the second carrier plate and supported by the corresponding pulley; a drum configured to wind another end side of each of the raising-side wire and the lowering-side wire; and a motor configured to drive the drum in both forward and reverse rotation directions. Each of the first and second guide rails includes a slid portion on which a sliding portion of the corresponding carrier plate is slidable in a direction separating the first and second guide rails from each other, and the slid portion of one guide rail of the first and second guide rails has a general portion extending parallel to an extending direction of the one guide rail, and a protruding portion protruding in a direction separating from the other guide rail of the first and second guide rails.

### CROSS REFERENCE TO RELATED APPLICATIONS

This application is based on and claims priority under 35 U.S.C. § 119 to Japanese Patent Application 2025-069085, filed on Apr. 18, 2025, the entire content of which is incorporated herein by reference.

### TECHNICAL FIELD

This disclosure relates to a window regulator.

### BACKGROUND DISCUSSION

As a window regulator of this type, JP 2024-136801A (Reference 1) discloses a window regulator including a pair of carrier plates fixed to a door glass, a pair of guide rails supporting the pair of carrier plates so as to be raised and lowered, support pulleys attached to upper and lower portions of the pair of guide rails, a raising-side wire having one end fixed to an upper portion of one carrier plate, a lowering-side wire having one end fixed to a lower portion of the other carrier plate, and a drive unit including a drum for winding the other end of each of the raising-side wire and the lowering-side wire and a motor for rotating the drum in both forward and reverse directions.

In such a window regulator, when a clearance is provided between slid portions of the pair of guide rails in a direction separating the guide rails from each other and sliding portions of the corresponding carrier plate, rattling occurs in the carrier plate, a position of the door glass to be fixed is difficult to stabilize, and assembly is difficult. On the other hand, when the clearance is reduced in order to eliminate the rattling, the guide rail and the carrier plate may strongly interfere with each other due to a tolerance of a component, and sliding resistance may increase or abnormal noise or the like may occur when the door glass is raised and lowered.

A need thus exists for a window regulator which is not susceptible to the drawback mentioned above.

### SUMMARY

A window regulator according to an aspect of this disclosure is a window regulator for raising and lowering a door glass of a vehicle door, the window regulator including: a first carrier plate and a second carrier plate each fixed to the door glass at a predetermined interval; a first guide rail extending in an upper-lower direction and into which the first carrier plate is slidably fitted; a second guide rail extending parallel to the first guide rail and into which the second carrier plate is slidably fitted; a plurality of pulleys respectively provided at end portions of the first and second guide rails in an extending direction; a raising-side wire having one end fixed to the first carrier plate and supported by the corresponding pulley; a lowering-side wire having one end fixed to the second carrier plate and supported by the corresponding pulley; a drum configured to wind another end side of each of the raising-side wire and the lowering-side wire; and a motor configured to drive the drum in both forward and reverse rotation directions. Each of the first and second guide rails includes a slid portion on which a sliding portion of the corresponding carrier plate is slidable in a direction separating the first and second guide rails from each other, and the slid portion of one guide rail of the first and second guide rails has a general portion extending parallel to an extending direction of the one guide rail, and a protruding portion protruding in a direction separating from the other guide rail of the first and second guide rails.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram of a window regulator according to the present embodiment and a partially enlarged view of a carrier plate;

FIG. 2 is an internal configuration diagram of the window regulator;

FIG. 3 is a schematic configuration diagram of the window regulator when a front carrier plate is located at a general portion of a front guide rail;

FIG. 4 is a cross-sectional view taken along a line IV-IV in FIG. 3;

FIG. 5 is a cross-sectional view taken along a line V-V in FIG. 3;

FIG. 6 is a schematic configuration diagram of the window regulator when the front carrier plate is located at a protruding portion of the front guide rail;

FIG. 7 is a cross-sectional view taken along a line VII-VII in FIG. 6;

FIG. 8 is a cross-sectional view taken along a line VIII-VIII in FIG. 6;

FIG. 9 is a schematic configuration diagram of the window regulator when the front carrier plate is located at a gradually changing portion of the front guide rail;

FIG. 10 is a cross-sectional view taken along a line X-X in FIG. 9;

FIG. 11 is a cross-sectional view taken along a line XI-XI in FIG. 9;

FIG. 12 is a schematic configuration diagram of the front guide rail;

FIG. 13 is a partial enlarged view of FIG. 12;

FIG. 14 is a schematic diagram schematically showing a slid portion of the front guide rail;

FIG. 15 is a schematic diagram schematically showing a slid portion of a front guide rail according to another embodiment; and

FIG. 16 is a diagram showing a state in which a door glass is raised by the guide rail and the carrier plate as viewed in a front-rear direction of a vehicle.

### DETAILED DESCRIPTION

Next, embodiments of this disclosure will be described with reference to the drawings.

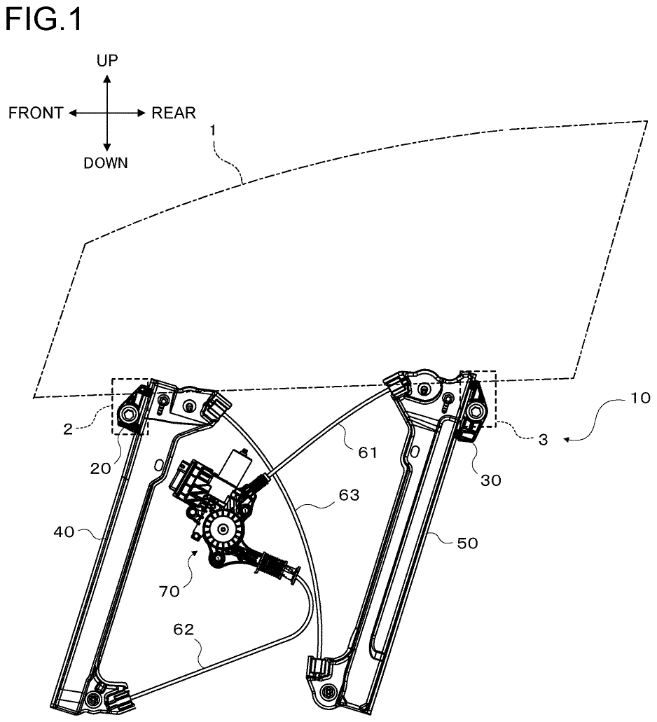

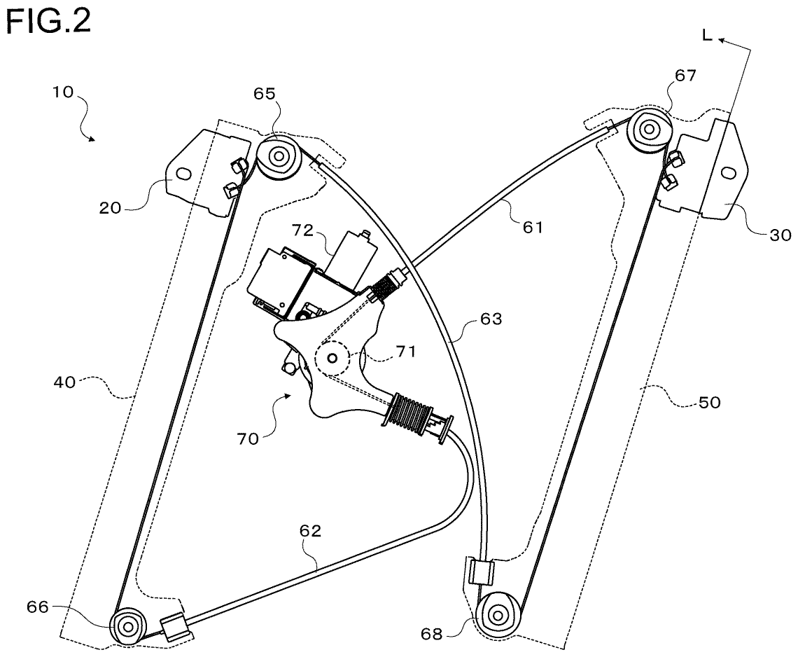

FIG. 1 is a schematic configuration diagram of a window regulator 10 according to the present embodiment and a partially enlarged view of carrier plates 20, 30. FIG. 2 is an internal configuration diagram of the window regulator 10.

The window regulator 10 according to the present embodiment is a window regulator in a vehicle door including a door panel and a door glass 1, and opens and closes an opening of the door panel by raising and lowering the door glass 1. In the present embodiment, the door is implemented by a sashless door, but may be a door including a door sash. The door panel includes an outer panel and an inner panel fixed to an inner side (vehicle compartment side) of the outer panel, and the window regulator 10 is attached inside the door panel. The window regulator 10 may be fixed to an inner surface side of the inner panel by bolts or the like, or may be attached to a resin panel fixed to the inner panel.

As shown in FIG. 1, the window regulator 10 according to the present embodiment includes a pair of carrier plates 20, 30 and a pair of guide rails 40, 50 that support the pair of carrier plates 20, 30 so as to be raised and lowered.

The pair of carrier plates 20, 30 are attached by bolts or the like to door holders 2, 3 fixed to a lower end portion of the door glass 1 at a predetermined interval in a front-rear direction of a vehicle. The carrier plate 20 is provided on a front side of the vehicle, and the carrier plate 30 is provided on a rear side of the vehicle. Therefore, the carrier plate 20 may be referred to as a front carrier plate 20, and the carrier plate 30 may be referred to as a rear carrier plate 30.

The pair of guide rails 40, 50 are fixed to the door panel so as to be separated from each other in the front-rear direction of the vehicle and extend parallel to each other in an upper-lower direction. The guide rail 40 is provided on the front side of the vehicle, and the guide rail 50 is provided on the rear side of the vehicle. Therefore, the guide rail 40 may be referred to as a front guide rail 40, and the guide rail 50 may be referred to as a rear guide rail 50.

As shown in FIG. 2, the window regulator 10 includes four pulleys 65, 66, 67, 68 provided on the pair of guide rails 40, 50, a raising wire 61 for raising the rear carrier plate 30, a lowering wire 62 for lowering the front carrier plate 20, a connecting wire 63 for connecting the pair of carrier plates 20, 30, and a drive device 70 for winding and unwinding the raising wire 61 and the lowering wire 62.

The drive device 70 is provided between the pair of guide rails 40, 50. The drive device 70 includes a drum 71 having a rotation shaft extending parallel to rotation shafts of the pulleys 65, 66, 67, 68, and a motor 72 that rotationally drives the drum 71. The motor 72 is connected to the drum 71 via a deceleration mechanism. The deceleration mechanism includes, for example, a worm provided on a rotation shaft of the motor 72 and a worm wheel provided coaxially with the drum 71 and meshing with the worm. The motor 72 is configured to rotationally drive the drum 71 in both forward and reverse rotation directions.

The pulleys 65, 66 are rotatably attached to upper and lower portions of the front guide rail 40, and the pulleys 67, 68 are rotatably attached to upper and lower portions of the rear guide rail 50. The pulley 65 may be referred to as a front upper pulley 65, the pulley 66 may be referred to as a front lower pulley 66, the pulley 67 may be referred to as a rear upper pulley 67, and the pulley 68 may be referred to as a rear lower pulley 68.

As shown in FIG. 2, one end of the raising wire 61 is fixed to the rear carrier plate 30, and the other end of the raising wire 61 is connected to the drum 71 of the drive device 70 so as to be capable of being wound and unwound. The raising wire 61 is supported by the rear upper pulley 67 in a reciprocatable manner. That is, the raising wire 61 is connected to the rear carrier plate 30 and the drum 71 in a state of being hung on the rear upper pulley 67.

As shown in FIG. 2, one end of the lowering wire 62 is fixed to the front carrier plate 20, and the other end of the lowering wire 62 is connected to the drum 71 of the drive device 70 so as to be capable of being wound and unwound. The lowering wire 62 is supported by the front lower pulley 66 in a reciprocatable manner. That is, the lowering wire 62 is connected to the front carrier plate 20 and the drum 71 in a state of being hung on the front lower pulley 66.

As shown in FIG. 2, one end of the connecting wire 63 is connected to the front carrier plate 20, and the other end of the connecting wire 63 is connected to the rear carrier plate 30. The connecting wire 63 is supported by the front upper pulley 65 in a reciprocatable manner and is supported by the rear lower pulley 68 in a reciprocatable manner. That is, the connecting wire 63 is connected to the front carrier plate 20 and the rear carrier plate 30 in a state of being hung on the front upper pulley 65 and the rear lower pulley 68.

The drive device 70 rotationally drives the drum 71 in one direction by the motor 72 to unwind the other end of the lowering wire 62 from the drum 71 and wind the other end of the raising wire 61 onto the drum 71. Accordingly, the rear carrier plate 30 is pulled upward and raised by the raising wire 61. In addition, the front carrier plate 20 is pulled upward and raised by the connecting wire 63 connected to the rear carrier plate 30. Accordingly, the pair of carrier plates 20, 30 can be raised by the drive device 70, so that the door glass 1 can be raised.

The drive device 70 rotationally drives the drum 71 in an opposite direction by the motor 72 to unwind the other end of the raising wire 61 from the drum 71 and wind the other end of the lowering wire 62 onto the drum 71. Accordingly, the front carrier plate 20 is pulled downward and lowered by the lowering wire 62. Further, the rear carrier plate 30 is pulled downward and lowered by the connecting wire 63 connected to the front carrier plate 20. Accordingly, the pair of carrier plates 20, 30 can be lowered by the drive device 70, so that the door glass 1 can be lowered.

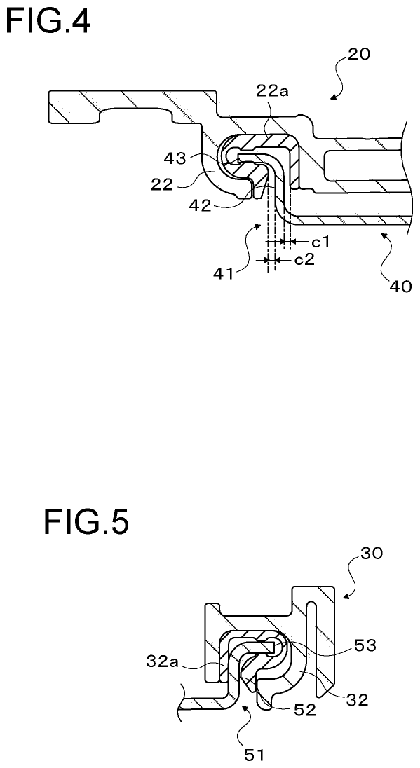

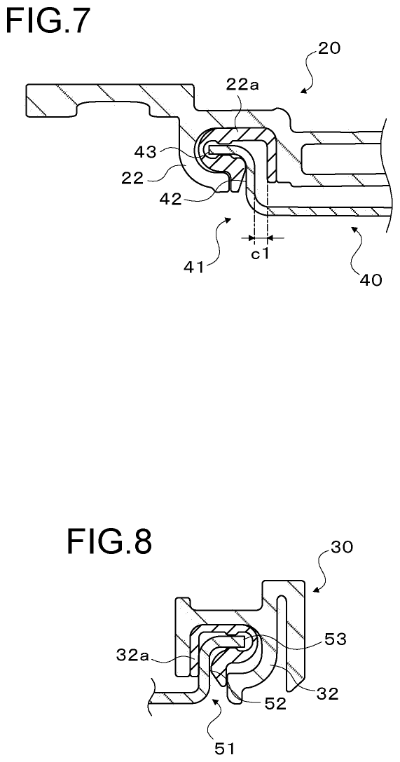

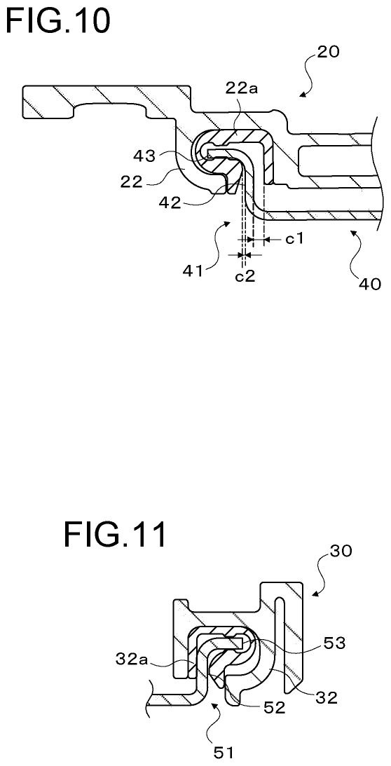

A stepped portion 41 (slid portion) bent to have a substantially parallel step is formed at an outer edge portion of the front guide rail 40 in a direction separating from the rear guide rail 50 (separation direction L) (see FIGS. 4, 7, 10, and 12). Similarly, a stepped portion 51 (slid portion)′ bent to have a substantially parallel step is formed at an outer edge portion of the rear guide rail 50 in a direction separating from the front guide rail 40 (see FIGS. 5, 8, and 11).

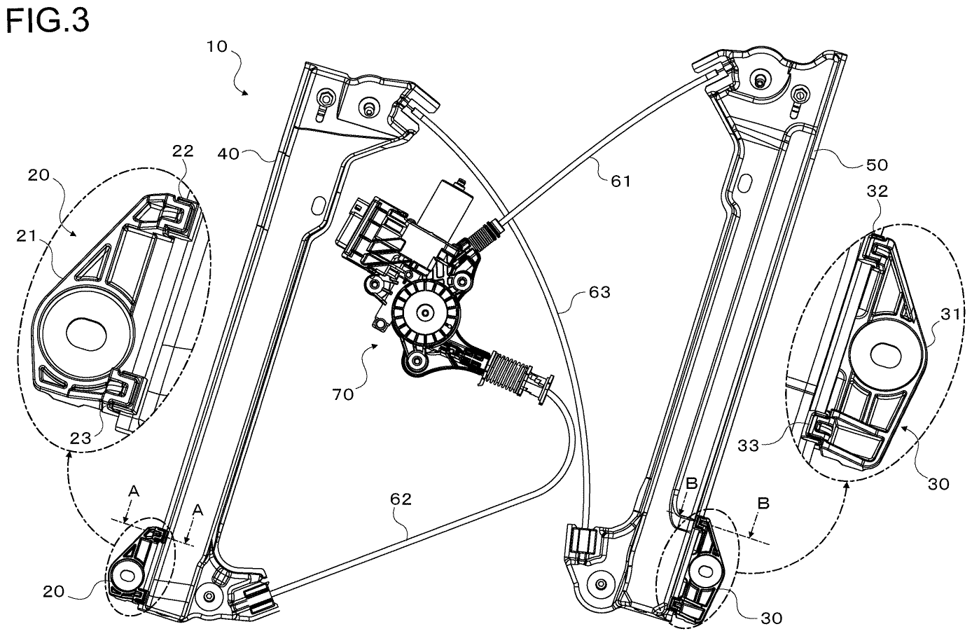

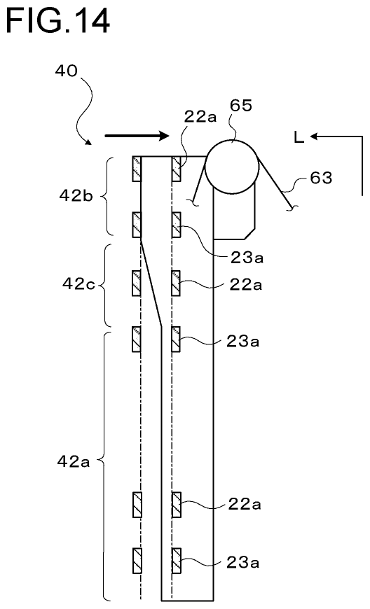

As shown in FIG. 3, the front carrier plate 20 includes a plate-shaped carrier plate main body 21 and fitting recesses 22, 23 (sliding portion) formed in the carrier plate main body 21 and fitted to the stepped portion 41 of the front guide rail 40 so as to be slidable in an extending direction of the front guide rail 40. The fitting recesses 22, 23 are formed in an upper portion and a lower portion of the carrier plate main body 21, respectively. As shown in FIGS. 4, 7, and 10, the fitting recess 22 is formed so as to surround the stepped portion 41 of the front guide rail 40 from a side wall 42 to an outer edge 43. The fitting recess 22 has a shoe 22a made of resin on an inner surface. The fitting recess 23 is also formed in the same manner as the fitting recess 22, and has a resin shoe 23a on an inner surface (see FIG. 14).

As shown in FIG. 3, the rear carrier plate 30 includes a plate-shaped carrier plate main body 31 and fitting recesses 32, 33 (sliding portion) fitted to the stepped portion 51 of the rear guide rail 50 so as to be slidable in an extending direction of the rear guide rail 50. The fitting recesses 32, 33 are formed in an upper portion and a lower portion of the carrier plate main body 31, respectively. As shown in FIGS. 5, 8, and 11, the fitting recess 32 is formed to surround the stepped portion 51 of the rear guide rail 50 from a side wall 52 to an outer edge 53. The fitting recess 32 has a resin shoe 32a on an inner surface. The fitting recess 33 is also formed in the same manner as the fitting recess 32, and has a resin shoe on an inner surface.

In addition, the side wall 52 of the stepped portion 51, which forms a slid portion of the rear guide rail 50 against the rear carrier plate 30, is formed flat along the extending direction from one end to the other end in the extending direction of the rear guide rail 50.

As shown in FIGS. 3, 5, 6, 8, 9, and 11, the fitting recesses 32, 33 of the rear carrier plate 30 are designed such that, in the entire region from one end to the other end in the extending direction of the rear guide rail 50, almost no clearance is generated on either side in the directions separating from and approaching the front guide rail 40 with respect to the side wall 52 of the rear guide rail 50.

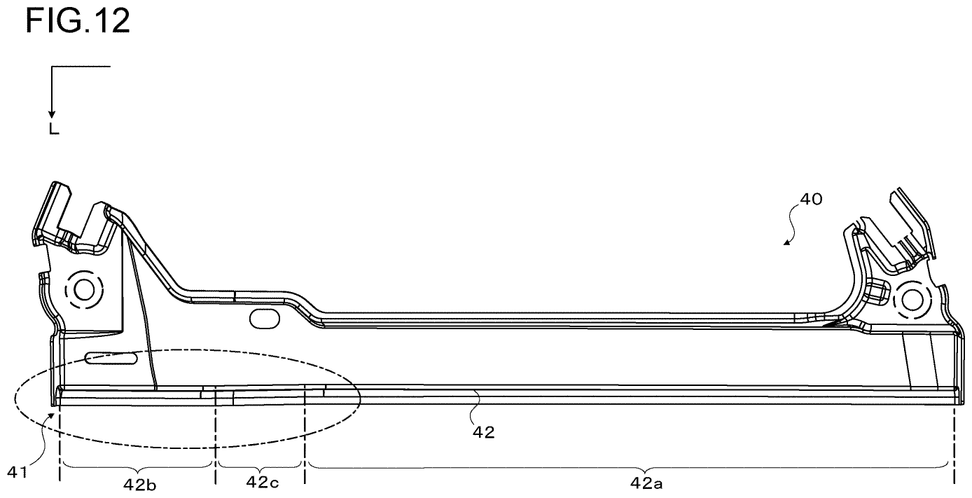

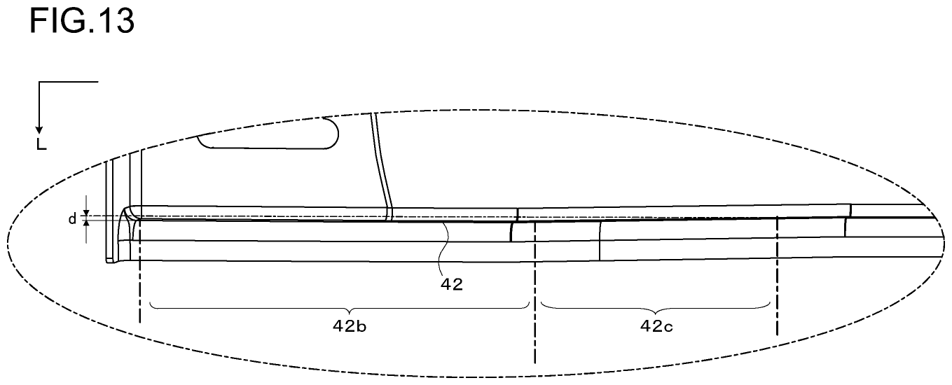

On the other hand, as shown in FIGS. 12 to 14, the side wall 42 of the stepped portion 41, which is a slid portion of the front guide rail 40 against the front carrier plate 20, has a general portion 42a formed flat along the extending direction of the front guide rail 40, a protruding portion 42b protruding in the direction separating from the rear guide rail 50 (the L direction in FIGS. 2 and 12 to 14), and a gradually changing portion 42c connecting the general portion 42a and the protruding portion 42b by an inclined surface. The protruding portion 42b is formed in an upper portion (upper end portion) of the front guide rail 40 over a range slightly longer than an interval between the two fitting recesses 22, 23 of the front carrier plate 20.

As shown in FIG. 3, the fitting recesses 22, 23 (sliding portion) of the front carrier plate 20 are designed such that when being located in the general portion 42a of the front guide rail 40, predetermined clearances c1 and c2 are formed on both sides of the side wall 42 of the front guide rail 40 in the directions separating from and approaching the rear guide rail 50 (the above-described L direction and the opposite direction).

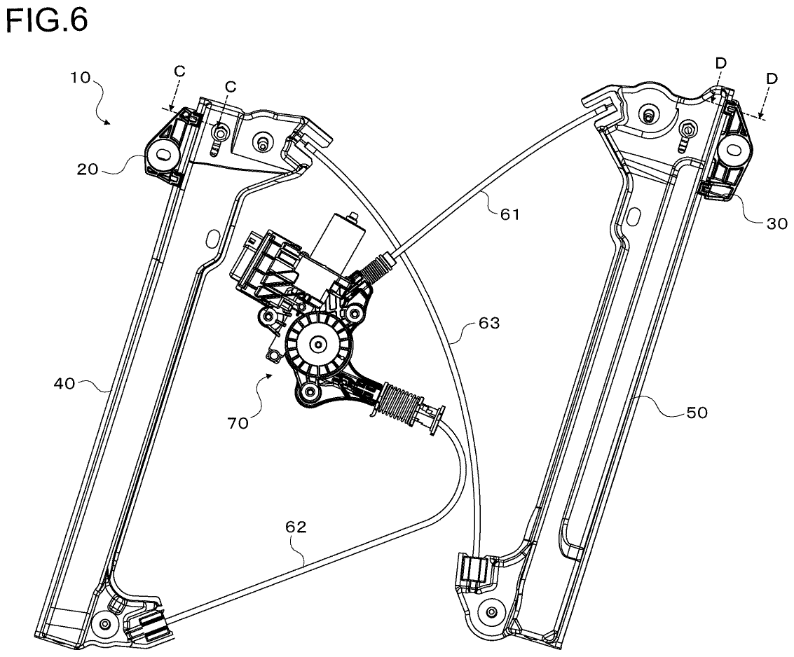

Further, as shown in FIGS. 6, 7, and 14, the protruding portion 42b of the front guide rail 40 is designed such that when the fitting recesses 22, 23 of the front carrier plate 20 are located at the upper end portion (top dead center) of the front guide rail 40, almost no clearance is generated with respect to the fitting recesses 22, 23 in the direction (L direction) separating from the rear guide rail 50. The front carrier plate 20 is pulled upward and raised by the connecting wire 63 hung on the front upper pulley 65 provided on the upper portion of the front guide rail 40. Therefore, when the front carrier plate 20 is raised, a load is applied to the upper portion of the front guide rail 40 in the direction approaching the rear guide rail 50 (see a thick arrow in FIG. 14). Therefore, a protruding amount of the protruding portion 42b is designed in consideration of deformation or the like due to a load applying on the front guide rail 40 when the front carrier plate 20 is raised.

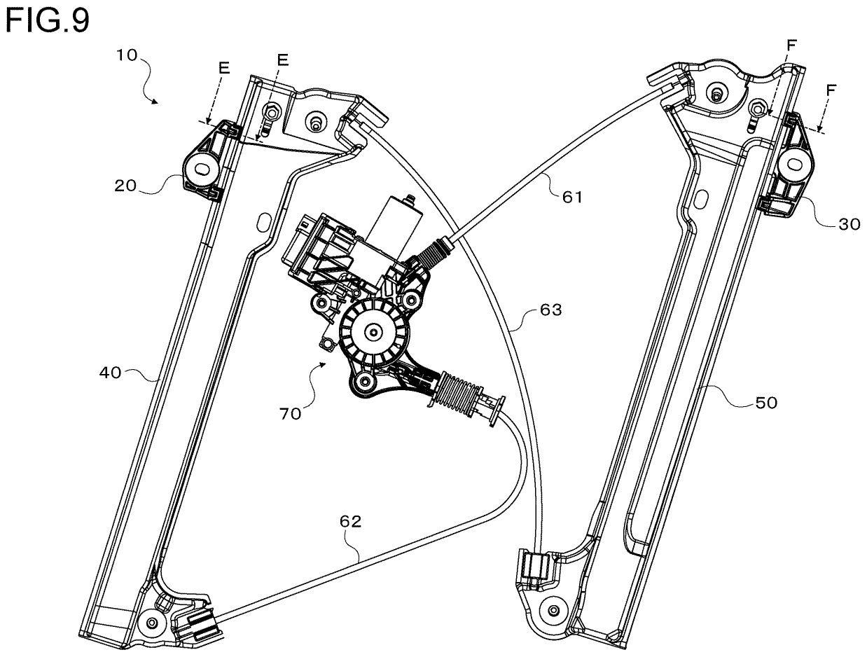

As shown in FIGS. 9, 10, and 14, the gradually changing portion 42c of the front guide rail 40 is designed such that, when the fitting recesses 22, 23 of the front carrier plate 20 pass through the gradually changing portion 42c of the front guide rail 40, the clearance c2 generated in the direction separating from the rear guide rail 50 with respect to the fitting recesses 22, 23 gradually decreases toward the upper end portion of the front guide rail 40.

A procedure for assembling the window regulator 10 according to the present embodiment having the above configuration and the door glass 1 will be described. First, the window regulator 10 is fixed to the door panel of the vehicle. The window regulator 10 may be set on a resin panel fixed to the door panel. Subsequently, the door glass 1 is set at an upper end portion of the window regulator 10. Next, the door holder 3 on a rear side of the door glass 1 is attached and fixed to the rear carrier plate 30 by bolt fastening. Then, the door holder 2 on a front side of the door glass 1 is attached and fixed to the front carrier plate 20 by bolt fastening. In the present embodiment, attachment holes of the rear carrier plate 30 and attachment holes of the front carrier plate 20 are formed as elongated holes or slotted holes. Therefore, even if an interval between the door holders 2, 3 varies, the door holder 2, 3 can be attached and fixed to the corresponding front carrier plate 20 and rear carrier plate 30 without any problem.

As described above, the side wall 52 (slid portion) of the stepped portion 51 of the rear guide rail 50 is formed flat along the extending direction of the rear guide rail 50 over the entire region in the extending direction. The fitting recesses 32, 33 of the rear carrier plate 30 are formed such that almost no clearance is generated on either side in the directions separating from and approaching the front guide rail 40 in the entire region in the extending direction of the rear guide rail 50. On the other hand, the flat general portion 42a along the extending direction of the front guide rail 40 and the protruding portion 42b protruding in the direction separating from the rear guide rail 50 are formed on the side wall 42 of the stepped portion 41 of the front guide rail 40. The fitting recesses 22, 23 of the front carrier plate 20 are formed such that the clearances c1 and c2 are generated on both sides in the directions separating from and approaching the rear guide rail 50 when the fitting recesses 22, 23 are located in the general portion 42a of the front guide rail 40, and such that almost no clearance is generated in the direction separating from the rear guide rail 50 when the fitting recesses 22, 23 are located in the protruding portion 42b of the front guide rail 40. Accordingly, when the pair of carrier plates 20, 30 are raised and lowered (except for the top dead center), an appropriate clearance is formed between the fitting recesses 22, 23 (sliding portion) of the front carrier plate 20 and the side wall 42 (slid portion) of the stepped portion 41 of the front guide rail 40. Therefore, even if a dimensional error or an assembly error of a component occurs, strong interference between the front carrier plate 20 and the front guide rail 40 can be effectively prevented, and the door glass 1 can be smoothly raised and lowered. On the other hand, when assembling the door glass 1 to the window regulator 10, by assembling the door glass 1 in a state in which the pair of carrier plates 20, 30 are located at the upper end portions of the pair of guide rails 40, 50, the pair of carrier plates 20, 30 can be assembled in a state in which there is no rattling, and the assemblability can be improved.

Further, since the gradually changing portion 42c smoothly connecting the general portion 42a and the protruding portion 42b is formed between the general portion 42a and the protruding portion 42b in the side wall 42 of the front guide rail 40, a movement of the front carrier plate 20 can be smoothly performed between the general portion 42a and the protruding portion 42b.

In addition, the fitting recesses 32, 33 (sliding portion) of the rear carrier plate 30 and the side wall 52 (slid portion) of the rear guide rail 50 are formed such that no clearance is generated on either side in the directions separating from and approaching the front guide rail 40. Therefore, even if a clearance is provided between the fitting recesses 22, 23 (sliding portion) of the front carrier plate 20 and the side wall 42 (slid portion) of the front guide rail 40, rattling of the door glass 1 can be minimized. Further, the assemblability of the door glass 1 can be improved only by forming the protruding portion 42b on the upper portion of the side wall 42 of the front guide rail 40.

It is needless to say that this disclosure is not limited to the above-described embodiments, and may be implemented in various aspects within the technical scope of this disclosure.

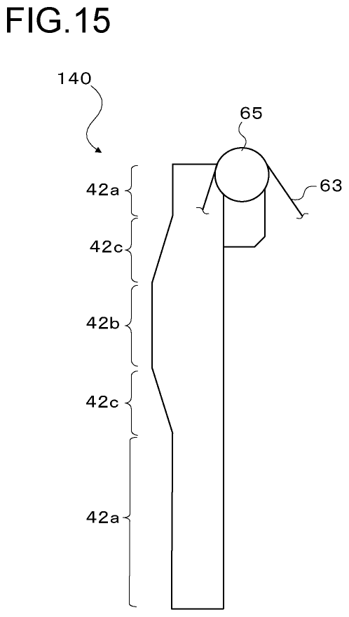

For example, in the above-described embodiment, the protruding portion 42b is formed at the upper portion (upper end portion) of the front guide rail 40, but as in a front guide rail 140 shown in FIG. 15, the protruding portion 42b may be formed at an intermediate portion between the upper portion and the lower portion. In this case, the general portions 42a may be formed in the upper portion and the lower portion, and the gradually changing portion 42c may be formed between the protruding portion 42b and both the general portions 42a.

In the above-described embodiment, the protruding portion 42b is formed on the front guide rail 40, but may be formed on the rear guide rail 50. That is, a function of the front guide rail 40 and a function of the rear guide rail 50 may be interchanged.

Further, in the above-described embodiment, the gradually changing portion 42c linearly connects the general portion 42a and the protruding portion 42b by the inclined surface, but may connect the general portion 42a and the protruding portion 42b by a smoothly curved surface.

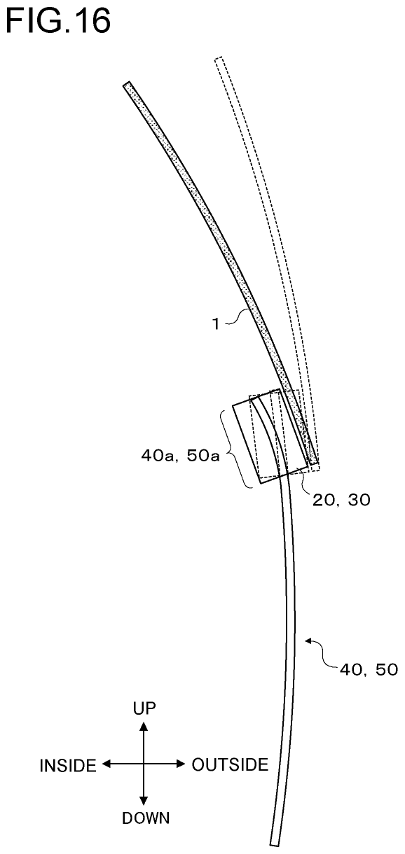

As shown in FIG. 16, the pair of guide rails 40, 50 and the door glass 1 are curved in an arc shape so as to have a concave curved surface toward the inside of the vehicle (vehicle interior side) as viewed from the front-rear direction of the vehicle. In the present embodiment, the pair of guide rails 40, 50 are formed so as to be curved with a radius of curvature corresponding to a radius of curvature of the door glass 1 except for the upper portion, and curved with a smaller radius of curvature at the upper portion than the other portions. In this manner, the door glass 1 can be tilted toward the inside of the vehicle (vehicle interior side) when the door glass 1 is raised, as compared with a case where the pair of guide rails 40, 50 are formed to be curved with a radius of curvature corresponding to the radius of curvature of the door glass 1 over the entire region (see the dotted line in the drawing). Accordingly, in the sashless door, the upper end portion of the door glass 1 can be pressed against a weather stripping (seal member) of a vehicle body to accurately position the door glass 1 at a closed position.

The present specification also discloses a technical idea in which the “window regulator according to any one of claim 1 or 2” in claim 4 at the time of filing is changed to the “window regulator according to any one of claims 1 to 3”.

### INDUSTRIAL APPLICABILITY

This disclosure is applicable to a window regulator manufacturing industry and the like.

A window regulator according to an aspect of this disclosure is a window regulator for raising and lowering a door glass of a vehicle door, the window regulator including: a first carrier plate and a second carrier plate each fixed to the door glass at a predetermined interval; a first guide rail extending in an upper-lower direction and into which the first carrier plate is slidably fitted; a second guide rail extending parallel to the first guide rail and into which the second carrier plate is slidably fitted; a plurality of pulleys respectively provided at end portions of the first and second guide rails in an extending direction; a raising-side wire having one end fixed to the first carrier plate and supported by the corresponding pulley; a lowering-side wire having one end fixed to the second carrier plate and supported by the corresponding pulley; a drum configured to wind another end side of each of the raising-side wire and the lowering-side wire; and a motor configured to drive the drum in both forward and reverse rotation directions. Each of the first and second guide rails includes a slid portion on which a sliding portion of the corresponding carrier plate is slidable in a direction separating the first and second guide rails from each other, and the slid portion of one guide rail of the first and second guide rails has a general portion extending parallel to an extending direction of the one guide rail, and a protruding portion protruding in a direction separating from the other guide rail of the first and second guide rails.

In the window regulator according to the above aspect of this disclosure, the slid portion of the one guide rail has the general portion extending parallel to the extending direction of the one guide rail and the protruding portion protruding in the direction separating from the other guide rail. By aligning the sliding portion of the carrier plate with the protruding portion of the slid portion of the guide rail, the window regulator can be assembled to the vehicle door in a state in which the door glass is stabilized. Further, by providing an appropriate clearance between the sliding portion of the carrier plate and the general portion of the slid portion of the guide rail, it is possible to prevent strong interference between the sliding portion of the carrier plate and the general portion of the slid portion of the guide rail when the door glass is raised and lowered even if dimensions of components vary. As a result, the window regulator can be easily assembled while preventing the strong interference between the guide rail and the carrier plate.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A window regulator for raising and lowering a door glass of a vehicle door, the window regulator comprising:
a first carrier plate and a second carrier plate each fixed to the door glass at a predetermined interval;
a first guide rail extending in an upper-lower direction and into which the first carrier plate is slidably fitted;
a second guide rail extending parallel to the first guide rail and into which the second carrier plate is slidably fitted;
a plurality of pulleys respectively provided at end portions of the first and second guide rails in an extending direction;
a raising-side wire having one end fixed to the first carrier plate and supported by the corresponding pulley;
a lowering-side wire having one end fixed to the second carrier plate and supported by the corresponding pulley;
a drum configured to wind another end side of each of the raising-side wire and the lowering-side wire; and
a motor configured to drive the drum in both forward and reverse rotation directions, wherein each of the first and second guide rails includes a slid portion on which a sliding portion of the corresponding carrier plate is slidable in a direction separating the first and second guide rails from each other, and
the slid portion of one guide rail of the first and second guide rails has a general portion extending parallel to an extending direction of the one guide rail, and a protruding portion protruding in a direction separating from the other guide rail of the first and second guide rails.

2. The window regulator according to claim 1, wherein the protruding portion is formed on an upper portion of the one guide rail.

3. The window regulator according to claim 1, wherein
the slid portion of the one guide rail has a gradually changing portion between the general portion and the protruding portion to connect the general portion and the protruding portion.

4. The window regulator according to claim 2, wherein
the slid portion of the one guide rail has a gradually changing portion between the general portion and the protruding portion to connect the general portion and the protruding portion.

5. The window regulator according to claim 1, wherein
a clearance between the slid portion of the other guide rail and the sliding portion of the corresponding carrier plate is smaller than a clearance between the general portion of the one guide rail and the sliding portion of the corresponding carrier plate.

6. The window regulator according to claim 2, wherein
a clearance between the slid portion of the other guide rail and the sliding portion of the corresponding carrier plate is smaller than a clearance between the general portion of the one guide rail and the sliding portion of the corresponding carrier plate.

7. The window regulator according to claim 1, wherein
the slid portion of the other guide rail is formed flat along an extending direction of the other guide rail over an entire region in the extending direction.

8. The window regulator according to claim 2, wherein
the slid portion of the other guide rail is formed flat along an extending direction of the other guide rail over an entire region in the extending direction.
